(19) United States
(12) Patent Application Publication
(10) Pub. No.: US 2006/0057927 A1
(43) Pub. Date: Mar. 16, 2006

(54) Fabrication method of field emitter electrode

(75) Inventors: Hyoung Dong Kang, Suwon (KR); Jong Myeon Lee, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 11/060,288

(22) Filed: Feb. 18, 2005

(30) Foreign Application Priority Data
Sep. 14, 2004 (KR) 10-2004-73560

(51) Int. Cl. H01J 9/04; H01J 9/14

(52) U.S. Cl. 445/46

(57) ABSTRACT

The present invention provides a process for fabricating a field emitter electrode, comprising dispersing carbon nanotubes and a conductive polymer in DI (deionized) water to prepare a carbon nanotube mixture having a viscosity of 50 to 100 cps; applying the carbon nanotube mixture to a substrate; and heat treating the carbon nanotube mixture to form a conductive polymer layer including carbon nanotubes.

### RELATED APPLICATION

The present application is based on, and claims priority from, Korean Application No. 2004-73560, filed on Sep. 14, 2004, the disclosure of which is incorporated by reference herein in its entirety.

### BACKGROUND OF THE INVENTION

1. Field of the Invention

The present invention relates to a process for fabricating a field emitter electrode, and more particularly to a novel process for fabricating a field emitter electrode in which low bond strength of carbon nanotubes, a disadvantage exhibited in a conventional electrophoretic method, is improved and the process is simplified.

2. Description of the Related Art

Generally, a field emission device is a light source based on electron emission in vacuum and refers to an element emitting light according to the principle by which electrons emitted from micro particles are accelerated by a strong electric field to impinge upon fluorescent materials. The above-mentioned field emission device has advantages such as excellent light emitting efficiency and capability of realizing light-weight and compactness as compared to conventional illumination light sources such as an incandescent bulb, as well as environmental friendliness due to no use of heavy metals unlike fluorescent lamps and therefore has received a great deal of attention as a next generation light source for use in a variety of illumination fields and displays.

The performance of the field emission device significantly depends on the emitter electrode's capability to emit an electric field. Recently, carbon nanotubes (CNT) have been actively used as the electron emitting material for the emitter electrode having excellent electron emission characteristics. However, it is difficult to uniformly grow carbon nanotubes on a large area substrate, and thus a process involving purifying carbon nanotubes grown by a separate process and depositing them on the substrate is generally used. Examples of representative methods for fabricating the carbon nanotube emitter electrode include typical printing methods and electrophoretic methods.

Fabricating the carbon nanotube emitter electrode by the conventional printing method is performed by coating an electrode layer on a flat-surfaced substrate, and printing paste made of carbon nanotubes and silver powder on the electrode layer. This is followed by removing resin and solvent contained in the paste through a heat treatment process and exposing a portion of carbon nanotubes from the surface of the cured layer using a tape method.

However, this method has disadvantages such as being a complicated process, and having difficulty in obtaining homogeneous dispersion of carbon nanotubes, and thereby characteristics of the field emitter electrode may be deteriorated. Further, there is another problem in obtaining sufficient physical/mechanical bonding between carbon nanotubes and lower electrode materials using known paste application processes.

Alternatively, the method for fabricating the carbon nanotube emitter electrode by electrophoresis is performed by mixing previously purified carbon nanotubes with a dispersing agent (for example, cationic dispersing agent) in an electrolyte, and then applying voltage to both electrodes dipped in the electrolyte, thereby depositing carbon nanotubes on the substrate provided on the anode, as shown in FIG. 1.

This method using electrophoresis can realize relatively homogeneous dispersion of carbon nanotubes and simplification of the overall process, but has a problem in that it is not suitable for an apparatus requiring a long service life due to low mechanical impact resistance resulting from weak bond strength of carbon nanotubes.

### SUMMARY OF THE INVENTION

Therefore, the present invention has been made in view of the above problems, and it is an object of the present invention to provide a process for fabricating a field emitter electrode capable of realizing process simplification, and having improved bond strength of carbon nanotubes and improved electrical characteristics, by applying and curing a carbon nanotube mixture including carbon nanotubes and a conductive polymer to prepare a conductive polymer layer including carbon nanotubes, unlike the conventional method.

In accordance with the present invention, the above and other objects can be accomplished by the provision of a process for fabricating a field emitter electrode, comprising dispersing carbon nanotubes and a conductive polymer in DI (deionized) water to prepare a carbon nanotube mixture having a viscosity of 50 to 100 cps; applying the carbon nanotube mixture to a substrate; and heat treating the carbon nanotube mixture applied to form a conductive polymer layer including carbon nanotubes.

Preferably, the carbon nanotube mixture is prepared using 0.01 to 0.05 wt % of carbon nanotubes, 2 to 5 wt % of the conductive polymer and the balance of DI water. Carbon nanotubes used in the present invention preferably have a length of 1 to 2 μm.

Preferably, the conductive polymer layer has a thickness of 0.5 to 2 μm such that carbon nanotubes can be exposed on the surface of the cured layer. The conductive polymer used in the present invention may be selected from the group consisting of polypyrrol, polyaniline, poly(3,4-ethylenedioxythiophene), polyacetylene, poly(p-phenylene), polythiophene, poly(p-phenylenevinylene) and poly(thienylene vinylene), but is not limited thereto.

Further, the step of applying the carbon nanotube mixture may be easily performed by conventional application processes, i.e., a process selected from the group consisting of spin coating, spray coating, screen printing and ink jet printing.

Preferably, in order to effect more homogeneous dispersion of carbon nanotubes, a dispersing agent may be additionally added to the carbon nanotube mixture. The dispersing agent may be at least one selected from cationic dispersing agents such as benzene konium chloride, polyethyleneimine and magnesium chloride (MgCl₂), or anionic dispersing agents such as sodium dodecyl sulfate.

In addition, in order to more homogeneously disperse carbon nanotubes during preparation of the carbon nanotube mixture, application of ultrasonic waves to the carbon nanotube mixture may be additionally performed.

Preferably, heat treatment of the carbon nanotube mixture can be effected by drying the carbon nanotube mixture at a temperature of 40 to 100° C. to evaporate DI water therefrom, and curing the resulting material thus dried at a temperature of 150 to 200° C.

Further, the process may further comprise etching the surface of the cured conductive polymer layer so as to expose carbon nanotubes.

One feature of the present invention is to fabricate the emitter electrode by applying the mixture including carbon nanotubes and a conductive polymer to the substrate, without performing a separate deposition process of carbon nanotubes as in the electrophoretic method. Thereby, the present invention can realize simplification of the overall process, and simultaneously, can secure homogeneous dispersion of carbon nanotubes and improvement of bond strength of carbon nanotubes and electric characteristics of the electrode by the conductive polymer filled in the spaces between carbon nanotubes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing an electrochemical polymerization process employed in a process for fabricating a field emitter electrode using a conventional electrophoretic method;

FIG. 2 is a process flow diagram illustrating a process for fabricating a field emitter electrode in accordance with the present invention; and

FIGS. 3a and 3b are SEMs showing a field emitter electrode fabricated in accordance with one embodiment of the present invention and showing emission states thereof, respectively.

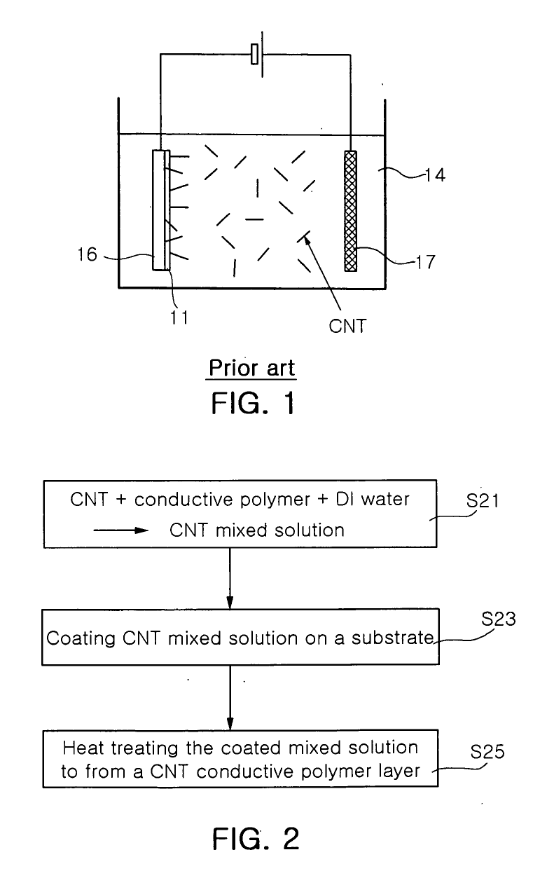

### DESCRIPTION OF THE PREFERRED EMBODIMENTS

The present invention will now be described in more detail with reference to the accompanying drawings and specific embodiments.

FIG. 2 is a process flow diagram illustrating a process for fabricating a field emitter electrode in accordance with the present invention.

As shown in FIG. 2, the process for fabricating a field emitter electrode of the present invention is initiated by dispersing carbon nanotubes and a conductive polymer in DI water to prepare a carbon nanotube mixture having a viscosity of 50 to 100 cps (S21).

The carbon nanotube mixture in accordance with the present invention has relatively low viscosity. This is to ensure homogeneous dispersion of carbon nanotubes and sufficient mixing of carbon nanotubes and conductive polymer. If the viscosity exceeds 100 cps, it is impossible to secure sufficient flowability of the mixture, thus failing to obtain homogeneous dispersion thereof. Conversely, if the viscosity is less than 50 cps, viscosity is too low to perform a subsequent application process.

Preferably, the carbon nanotube mixture is prepared by suitably mixing 0.01 to 0.05 wt % of carbon nanotubes, 2 to 5 wt % of the conductive polymer, and the balance of DI water. Carbon nanotubes used in the present invention can be obtained by grinding multi-wall or single wall carbon nanotubes prepared using CVD or arc-discharge and then purifying them using known processes such as field flux flow separation. Preferably, carbon nanotubes having a length of 1 to 2 μm may be used.

Further, the conductive polymer used in the present invention can be selected from the group consisting of polypyrrol, polyaniline, poly(3,4-ethylenedioxythiophene), polyacetylene, poly(p-phenylene), polythiophene, poly(p-phenylenevinylene) and poly(thienylene vinylene), but is not limited thereto.

If necessary, a dispersing agent may be further added to the carbon nanotube mixture. As dispersing agents utilizable for the present invention, at least one cationic dispersing agent selected from benzene konium chloride, polyethyleneimine and magnesium chloride (MgCl₂), or anionic dispersing agents such as sodium dodecyl sulfate may be used.

In addition, in order to more homogeneously disperse carbon nanotubes, application of ultrasonic waves to the carbon nanotube mixture may be performed.

Next, the carbon nanotube mixture is applied to a substrate as shown in step (S23). Since the present invention does not use the conventional electrophoretic method, the substrate is not limited to a conductive substrate. If desired, an insulative substrate may be used. Further, in the final process, only the conductive polymer film including carbon nanotubes may be separated from the substrate and used. This application process may use known application processes such as spin coating, spray coating, screen printing and ink jet printing. Preferably, spin coating, advantageous for uniform thickness application of a low viscosity solution, is used.

Finally, the carbon nanotube mixture is heat treated to form a conductive polymer layer including carbon nanotubes as shown in step (S25). Since the carbon nanotube mixture comprises significant parts of DI water, it is preferred to evaporate DI water by a drying process and thereafter to perform heat treatment in order to cure the conductive polymer components. Preferably, this step may include the steps of drying at a temperature of 40 to 100° C. and curing the resulting material dried at a temperature of 150 to 200° C.

Further, if desired, the additional process of etching the surface of the cured conductive polymer layer to sufficiently expose carbon nanotubes therefrom may be carried out. The conductive polymer layer may be separated from the substrate and then used as a ductile emitter electrode. Therefore, the emitter electrode fabricated in accordance with the present invention has high processability and may be used in field emission devices having various structures.

### EXAMPLE

First, in order to prepare a carbon nanotube mixture in accordance with the present invention, 3 g of poly(3,4-ethylenedioxythiophene) (Baytron P, Bayer) as a conductive polymer, and 15 mg of multi-wall carbon nanotubes prepared by CVD were weighed. The conductive polymer and carbon nanotubes were mixed in 97 g of deionized water to prepare a desired carbon nanotube mixture. In order to improve substrate bond strength, 4 g of isopropenol, 1.5 g of ethylene glycol, 1.2 g of tetraethoxy silane and 1 g of acetic acid (100%), and 30 mg of benzene konium chloride (BKC) as a dispersing agent were additionally added to the carbon nanotube mixture. The carbon nanotube mixture was measured to have a viscosity of about 90 cps.

In this example, in order to accomplish homogeneous dispersion of carbon nanotubes, the carbon nanotube mixture was subjected to ultrasonic waves for 1 hour.

The carbon nanotube mixture thus obtained was applied to a copper substrate and then a spin coating process was performed. First, it was spun for 5 sec at a 450 rpm so as to be evenly dispersed over the surface of the substrate and then was adjusted to a suitable application thickness by spinning it for 10 sec at 1500 rpm.

Then, the carbon nanotube mixture thus applied was placed in a drying oven and dried at a temperature of 50° C. for 10 min, followed by additional heat treatment for 30 min at a temperature of 180° C. to cure conductive polymer components in the carbon nanotube mixture.

As a result, the conductive polymer layer including about 0.28 μm carbon nanotubes was formed on the copper substrate and thereby it was possible to fabricate the desired field emitter electrode.

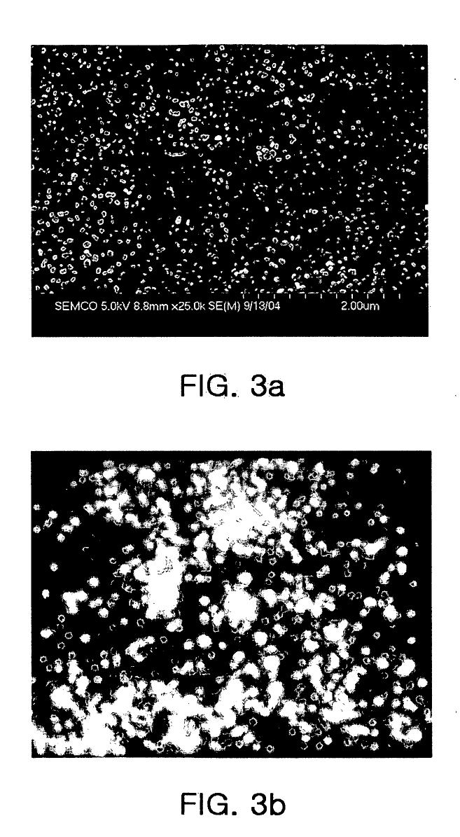

FIG. 3a is an SEM of a field emitter electrode in accordance with this example. As can be confirmed from FIG. 3a, carbon nanotubes were relatively uniformly arranged over the entire surface area. A light emitting experiment was carried out by applying the emitter electrode of this example to a light emitting device. As can be confirmed from FIG. 3b, the emitter electrode of this example exhibited excellent light emitting characteristics.

As apparent from the above description, in accordance with the present invention, a process for fabricating an emitter electrode using a low viscosity mixture in which carbon nanotubes and a conductive polymer are homogeneously dispersed is provided. Thereby, the present invention can realize simplification of the overall process without using a separate carbon nanotube deposition process, and simultaneously, can secure homogeneous dispersion of carbon nanotubes and improvement of bond strength of carbon nanotubes and electric characteristics of the electrode by the conductive polymer filled in the spaces between carbon nanotubes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A process for fabricating a field emitter electrode, comprising the steps of:
dispersing carbon nanotubes and a conductive polymer in DI (deionized) water to prepare a carbon nanotube mixture having a viscosity of 50 to 100 cps;
applying the carbon nanotube mixture to a substrate; and
heat treating the carbon nanotube mixture applied to form a conductive polymer layer including carbon nanotubes.

2. The process as set forth in claim 1, wherein the step of preparing the carbon nanotube mixture includes mixing 0.01 to 0.05 wt % of carbon nanotubes with 2 to 5 wt % of the conductive polymer in DI water.

3. The process as set forth in claim 1, wherein the carbon nanotubes have a length of 1 to 2 μm.

4. The process as set forth in claim 1, wherein the conductive polymer layer has a thickness of 0.5 to 2 μm.

5. The process as set forth in claim 1, wherein the conductive polymer is selected from the group consisting of polypyrrol, polyaniline, poly(3,4-ethylenedioxythiophene), polyacetylene, poly(p-phenylene), polythiophene, poly(p-phenylenevinylene) and poly(thienylene vinylene).

6. The process as set forth in claim 1, wherein the step of applying the carbon nanotube mixture is carried out by a process selected from the group consisting of spin coating, spray coating, screen printing and ink jet printing.

7. The process as set forth in claim 1, wherein a dispersing agent is additionally added to the carbon nanotube mixture.

8. The process as set forth in claim 1, wherein the dispersing agent is at least one cationic dispersing agent selected from benzene konium chloride, polyethyleneimine and magnesium chloride (MgCl₂), or an anionic dispersing agent such as sodium dodecyl sulfate.

9. The process as set forth in claim 1, wherein the step of preparing the carbon nanotube mixture further comprises subjecting the carbon nanotube mixture to ultrasonic waves, in order to more homogeneously disperse carbon nanotubes.

10. The process as set forth in claim 1, wherein the step of heat treating the carbon nanotube mixture comprises drying the carbon nanotube mixture at a temperature of 40 to 100° C. to evaporate DI water therefrom, and curing the resulting dried material at a temperature of 150 to 200° C.

11. The process as set forth in claim 1, further comprising:
etching the surface of the cured conductive polymer layer so as to expose carbon nanotubes.
